(19) United States
(12) Patent Application Publication
(10) Pub. No.: US 2025/0388798 A1
(43) Pub. Date: Dec. 25, 2025

(54) POLYALPHA-OLEFINS FOR IMPROVING THERMAL MANAGEMENT OF ELECTRIC MOTORS AND OTHER ELECTRIC HEAT SOURCES

(71) Applicant: ExxonMobil Technology and Engineering Company, Spring, TX (US)

(72) Inventors: Babak LOTFI, New Hope, PA (US); Gordon Hunter LEE, Southampton, PA (US); Ahmet CECEN, Houston, TX (US)

(73) Assignee: ExxonMobil Technology and Engineering Company, Spring, TX (US)

(21) Appl. No.: 19/217,873

(22) Filed: May 23, 2025

Related U.S. Application Data
(60) Provisional application No. 63/663,569, filed on Jun. 24, 2024.

(51) Int. Cl. C09K 5/10

(52) U.S. Cl. CPC C09K 5/10

(57) ABSTRACT

Methods for transferring heat from an electric heat source may comprise: providing a heat transfer fluid comprising about 3 wt % to about 99.99 wt % of a polyalpha-olefin (PAO), based on a total weight of the heat transfer fluid; contacting the heat transfer fluid with at least a portion of an electric heat source; and removing heat from the electric heat source with the heat transfer fluid. The PAO comprises about 10 mol % or less olefinic bonds and is a C22-C32 trimer of one of more C4-C12 linear alpha-olefins having a kinematic viscosity at 100° C. (Kv100), determined pursuant to ASTM D445, of about 1.8 cSt to about 4.5 cSt.

### CROSS REFERENCE TO RELATED APPLICATION

This application claims priority to U.S. Provisional Application 63/663,569 filed Jun. 24, 2024 and titled “POLYALPHA-OLEFINS FOR IMPROVING THERMAL MANAGEMENT OF ELECTRIC MOTORS AND OTHER ELECTRIC HEAT SOURCES” the entirety of which is incorporated herein by reference.

### FIELD

The present disclosure generally relates to thermal management, and, more particularly, to thermal management of electric motors, such as in electric vehicles, or other electric heat sources.

### BACKGROUND

Electric vehicles and their electric motors may afford a lower environmental impact than conventional hydrocarbon-powered vehicles and their internal combustion engines. Electric motors additionally may provide certain performance benefits over internal combustion engines, such as, for example, lower noise and higher torque from standstill, the latter of which results in quicker acceleration and more responsive handling. Although electric motors typically generate less heat than internal combustion engines, electric motors still generate a considerable amount of heat. If not properly dissipated, the excess heat can damage the motor and cause operational inefficiency. For example, in electric motors with permanent magnets, partial or full demagnetization of the magnets may occur if certain temperature thresholds are reached due to poor heat dissipation.

A variety of cooling strategies may be utilized to dissipate excess heat from electric motors. One approach for dissipating excess heat may utilize a heat transfer fluid to convey excess heat away from the electric motor. While a variety of suitable heat transfer fluids are known, they are not necessarily applicable in all operating conditions or electric motor configurations.

In view of the foregoing, there remains a need for heat transfer fluids having improved performance for use in conjunction with thermal management of electric motors and other electric heat sources.

### SUMMARY

In various aspects, methods of the present disclosure comprise: providing a heat transfer fluid comprising about 3 wt % to about 99.99 wt % of a polyalpha-olefin (PAO), based on total weight of the heat transfer fluid; wherein the PAO comprises about 10 mol % or less olefinic bonds and is a C22-C32 trimer of one of more C4-C12 linear alpha-olefins having a kinematic viscosity at 100° C. (Kv100), determined pursuant to ASTM D445, of about 1.8 cSt to about 4.5 cSt; contacting the heat transfer fluid with at least a portion of an electric heat source; and removing heat from the electric heat source with the heat transfer fluid.

In various aspects, systems of the present disclosure comprise: a heat transfer fluid comprising about 3 wt % to about 99.99 wt % of a polyalpha-olefin (PAO), based on a total weight of the heat transfer fluid; wherein the PAO comprises about 10 mol % or less olefinic bonds and is a C22-C32 trimer of one of more C4-C12 linear alpha-olefins having a kinematic viscosity at 100° C. (Kv100), determined pursuant to ASTM D445, of about 1.8 cSt to about 4.5 cSt; and an electric heat source having at least a portion thereof in contact with the heat transfer fluid.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a graph showing the rpm and time and the corresponding temperature profile of the base oil in the examples.

FIG. 2 is a graph of probability density as a function of temperature for various base oils under the tested operating conditions in the examples.

FIGS. 3-5 are graphs showing the thermal cooling efficiency of the base oils in a test motor under various testing conditions in the examples.

FIGS. 6-10 are graphs of temperature as a function of flow rates for various base oils in comparison to one another in the examples.

FIG. 11 is a diagram of an illustrative electric motor suitable for use in conjunction with the present disclosure.

### DETAILED DESCRIPTION

The present disclosure generally relates to thermal management, and, more particularly, to thermal management of electric motors, such as in electric vehicles, or other electric heat sources.

As discussed above, there are difficulties associated with thermal management of electric motors using conventional heat transfer fluids. In response to the foregoing issues, the present disclosure provides heat transfer fluids containing polyalpha-olefins that may provide a number of benefits in conjunction with promoting thermal management of electric motors and other electric heat sources, such as batteries, electronics, and data center servers, for example. Among other advantages, the heat transfer fluids disclosed herein have convenient viscosity properties and may afford fast cooling times of conductors and other components present in electric heat sources, such as electric motors. Since the resistance of conductors typically increases with temperature, lowering the temperature through effective thermal management may decrease resistance of the conductors and lead to higher power output at a fixed current. Alternately, by reducing resistance, an electric motor may utilize a smaller permanent magnet to still produce the same power as a larger magnet. By using smaller magnets, the weight of an electric vehicle may be reduced, which may improve operating range. Further advantageously, by providing effective thermal management, electric motor systems described herein may utilize higher currents than would otherwise be feasible but without reaching temperatures that might otherwise damage the electric motors or otherwise result in inefficient operation thereof. Lower circulation rates of the heat transfer fluid to the electric motor may also be possible compared to other heat transfer fluids providing less effective thermal management, while still accomplishing effective removal of a similar amount of heat. Similar advantages may be realized with other types of electric heat sources.

Heat transfer fluids of the present disclosure may comprise: about 3 wt % to about 99.99 wt % of at least one polyalpha-olefin (PAO), based on total weight of the heat transfer fluid, wherein the at least one PAO comprises about 10 mol % olefinic bonds or less and has a kinematic viscosity at 100° C. (Kv100), determined pursuant to ASTM D445, of about 1.8 cSt to about 4.5 cSt. Preferably, the at least one PAO is a C22-C32 trimer of one of more C4-C12 linear alpha-olefins. In accordance with the present disclosure, the heat transfer fluids may be contacted with an electric motor, an electric heat source, or a portion thereof to promote removal of heat therefrom.

Although the PAO alone may be sufficient, the heat transfer fluids may optionally comprise further additives. For example, the balance of the heat transfer fluids may comprise conventional base oils or other additives configured to tailor the properties of the heat transfer fluids toward a given application. Accordingly, the heat transfer fluids may further comprise one or more API Class I, II, III, IV, or V base oils or other additives, examples of which will be familiar to one having ordinary skill in the art.

In some examples, the at least one PAO may have a kinematic viscosity at 100° C. (Kv100), determined pursuant to ASTM D445, of about 3.0 cSt to about 4.5 cSt, and a Noack volatility (NV), determined pursuant to ASTM D5800, of about 15% or less. The at least one PAO may comprise about 10 mol % or less olefinic bonds and is a C22-C32 trimer of one of more C4-C12 linear alpha-olefins.

In some examples, the at least one PAO may have a kinematic viscosity at 100° C. (Kv100), determined pursuant to ASTM D445, of about 1.8 cSt to about 2.8 cSt, and a Noack volatility (NV), determined pursuant to ASTM D5800, of about 57% or less. The at least one PAO may comprise about 10 mol % or less olefinic bonds and is a C22-C32 trimer of one of more C4-C12 linear alpha-olefins.

The term “polyalpha-olefin(s)” (PAO(s)) includes any oligomer(s) and/or polymer(s) of onc or more alpha-olefin monomer(s). Alpha-olefins have a terminal double bond on their carbon chain. PAOs may be produced from the polymerization reaction of alpha-olefin monomer molecules in the presence of a catalyst and optionally further hydrogenated to remove residual carbon-carbon double bonds (olefinic bonds) therefrom. PAOs may be dimers, trimers, tetramers, or even higher oligomers derived from one or more alpha-olefin monomers. Preferably, at least a majority of the PAOs in the heat transfer fluids is a trimer. The PAOs may be highly regio-regular such that the bulk material exhibits isotacticity or syndiotacticity when assayed by 13C NMR. The PAOs may be highly regio-irregular such that the bulk material is substantially atactic when assayed by 13C NMR. In non-limiting examples, PAOs may be made using metallocene-based catalysts or traditional non-metallocene based catalysts (e.g., Lewis acids, supported chromium oxide, or the like).

The heat transfer fluids described herein may comprise about 3 wt % to about 99.99 wt % PAOs, about 3 wt % to about 99 wt % PAOs, or about 3 wt % to about 98 wt % PAOs, or about 50 wt % to about 98 wt % PAOs, based on total weight of the heat transfer fluid. The PAOs described herein have desirably low viscosity and low volatility to support their use in promoting heat transfer.

The PAOs may comprise olefinic bonds in an amount of about 10 mol % or less, or about 5 mol % or less, or about 3 mol % or less, or about 1 mol % or less, based on a total molar amount of the PAOs. Thus, the PAOs may be partially unsaturated or fully saturated PAOs. Preferably, the PAOs are substantially fully saturated. Any double bonds that do remain in the PAOs may include one or more of vinyl, disubstituted vinylene, trisubstituted vinylene, or vinylidene. The extent of unsaturation and amount of these types of double bonds may be determined by NMR spectroscopy, for example, or other applicable analytical techniques. The PAOs may contain a plurality of alkyl groups extending as side chains from the main backbone of the PAOS. The alkyl groups and the length thereof may be determined by the alpha-olefins that undergo oligomerization to form the PAOs. In non-limiting examples, the alkyl groups may be, for instance, n-butyl, n-hexyl, n-octyl, n-decyl, n-dodecyl, or any combination thereof.

The extent of oligomerization and the size of the alkyl groups may determine the overall number of carbon atoms in the one or more PAOs.

In non-limiting examples, the one or more PAOs may comprise C22-C32, or C24-C32, or C26-C32, or C28-C32 polyalpha-olefin oligomers at a total concentration of about 90 wt % or greater, or about 92 wt % or greater, or about 94 wt % or greater, or about 95 wt % or greater, or about 96 wt % or greater, or about 97 wt % or greater, or about 98 wt % or greater, based on total weight of the one or more PAOs. Such PAOs may comprise C30 polyalpha-olefin oligomers at a total concentration of about 90 wt % or greater, or about 92 wt % or greater, or about 94 wt % or greater, or about 95 wt % or greater, or about 96 wt % or greater, or about 97 wt % or greater, or about 98 wt % or greater, based on total weight of the one or more PAOs. Fully saturated C30 PAOs may be represented by the formula C₃₀H₆₂, which may be a single alkane isomer or a mixture of multiple (e.g., two, three, four, or more) alkane isomers.

In non-limiting examples, the one or more PAOs may comprise C22-C26, or C24-C26, or C22-C24 polyalpha-olefin oligomers at a total concentration of about 90 wt % or greater, or about 92 wt % or greater, or about 94 wt % or greater, or about 95 wt % or greater, or about 96 wt % or greater, or about 97 wt % or greater, or about 98 wt % or greater, based on total weight of the one or more PAOs. Such PAOs may comprise C24 polyalpha-olefin oligomers at a total concentration of about 90 wt % or greater, or about 92 wt % or greater, or about 94 wt % or greater, or about 95 wt % or greater, or about 96 wt % or greater, or about 97 wt % or greater, or about 98 wt % or greater, based on total weight of the one or more PAOs. Fully saturated C24 PAOs may be represented by the formula C24H50, which may be a single alkane isomer or a mixture of multiple (e.g., two, three, four, or more) alkane isomers.

In some examples, the one or more PAOs may have a KV100 of about v1 to about v2 cSt, where v1 and v2 can be, independently, 3.0, 3.1, 3.2, 3.3, 3.4, 3.5, 3.6, 3.7, 3.8, 3.9, 4.0, 4.1, 4.2, 4.3, 4.4, and 4.5, where v1 and v2 are determined according to ASTM D445 and v1<v2. Preferably, v1=3.0, and v2=4.0. More preferably, v1=3.0, and v2=3.6, or v1=3.0, and v2=3.5. Such PAOs may have a NV of about 15.0 wt % or less, or about 14.0 wt % or less, or about 13.0 wt % or less, or about 12.5 wt % or less, each determined pursuant to ASTM D5800. Preferably, such PAOs may have a NV of about 8 wt % to about 15 wt % or about 10 wt % to about 14 wt %.

In some examples, the one or more PAOs may have a KV100 of about v1 to about v2 cSt, where v1 and v2 can be, independently, 1.8, 1.9, 2.0, 2.1, 2.2, 2.3, 2.4, 2.5, 2.6, 2.7, or 2.8, where v1 and v2 are determined according to ASTM D445 and v1<v2. Preferably, v1=2.0, and v2=2.6. More preferably, v1=2.1, and v2=2.5. Such PAOs may have a NV of about 60 wt % or less, or about 55.0 wt % or less, or about 50 wt % or less, each as determined pursuant to ASTM D5800. Preferably, such PAOs may have a NV of about 50 wt % to about 58 wt % or about 52 wt % to about 56 wt %. Heat capacity and thermal conductivity values for the one or more PAOs are conducive to heat transfer and may facilitate their usage in heat transfer fluids of the present disclosure. For example, at 20° C., the one or more PAOs may have a heat capacity (Cp) ranging from about 2.100 J/(g·° C.) to about 2.130 J/(g·° C.) and a thermal conductivity ranging from about 0.135 W/(m·° C.) to about 0.155 W/(m·° C.); at 50° C., the one or more PAOs may have a heat capacity ranging from about 2.210 J/(g·° C.) to about 2.230 J/(g·° C.) and a thermal conductivity ranging from about 0.135 W/(M·° C.) to about 0.150 W/(m·° C.); and at 100° C., the one or more PAOs may have a heat capacity (Cp) ranging from about 2.390 J/(g·° C.) to about 2.405 J/(g·° C.) and a thermal conductivity ranging from about 0.125 W/(m·° C.) to about 0.140 W/(m·° C.). All thermal conductivity values in this disclosure are determined pursuant to ASTM D7896-19 and are reported in W/(m·° C.), unless otherwise specified. All heat capacity values in this disclosure are determined pursuant to ASTM D2766 and are reported in J/(g·° C.), unless otherwise specified.

The one or more PAOs may have a cold-cranking-simulator viscosity (CCSV) at −35° C. of about a1 to about a2 centipoise (cP), where a1 and a2 may be, independently, 500, 550, 600, 650, 700, 750, 800, 850, 900, or 1000, provided that a1 is less than a2. All CCSV values in this disclosure are determined according to ASTM D5293 and are reported in cP (milliPascal·second), unless otherwise specified.

The one or more PAOs may have a high-temperature, high-shear viscosity (HTHSV) at 150° C. of about 2 cP or less, or about 1.8 cP or less, or about 1.6 cP or less, or about 1.4 cP or less, such as about 1.0 cP to about 1.8 cP, about 1.0 cP to about 1.4 cP, or about 1.0 cP to about 1.2 cP, or or about 1.0 cP to about 1.3 cP. All HTHSV values in this disclosure are determined according to ASTM D5481 and are reported in cP, unless otherwise specified.

The one or more PAOs may have a high oxidation stability indicated by a rotating pressure vessel oxidation test (RPVOT) break time of at least about 30 minutes, or at least about 40 minutes, or at least about 50 minutes, or at least about 60 minutes, or at least about 70 minutes, or at least about 80 minutes. All RPVOT values in this disclosure are determined pursuant to ASTM D2272 and are reported in minutes, unless otherwise specified.

Electric heat sources suitable for use in conjunction with the present disclosure are not believed to be particularly limited. In non-limiting examples, the electric heat source may comprise an electric motor, an electronic component, a battery, or a data center server. The electric motor may be located in an electric vehicle, for example. The heat transfer fluid may be circulated through the electric heat source and/or the electric heat source may be at least partially immersed in the heat transfer fluid. Alternately, the heat transfer fluid may be sprayed on the electric motor or other electric heat source or any component thereof.

Electric motors suitable for use in conjunction with the present disclosure are not believed to be particularly limited. Suitable electric motors may be induction or permanent magnet motors. The electric motors may be present in an electric vehicle when undergoing thermal management according to the disclosure herein.

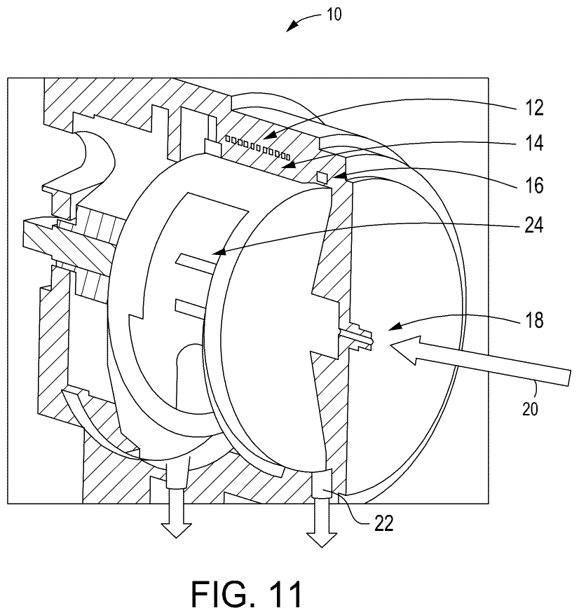

FIG. 11 is a diagram of an illustrative electric motor suitable for use in conjunction with the present disclosure. Electric motor 10 comprises jacket 12 positioned around stator 14 with electrical windings 16. Electric motor 10 further includes rotor 18 with fluid inlet centrifugal 20 extending through rotor 18.

To promote heat removal, the heat transfer fluid may contact at least a portion of electric motor 10. Contacting the heat transfer fluid with electric motor 10 may include circulating the heat transfer fluid through jacket 12, rotor 18, and fluid inlet centrifugal 20. The heat transfer fluid may further flow through at least one fluid drain 22. These components may define at least a portion of a circuit through which the heat transfer fluid may flow to promote heat removal from electric motor 10.

Suitable electric motors may comprise at least one permanent magnet. The at least one permanent magnet is not evident in FIG. 11, but may be positioned on rotor core 24 in non-limiting examples. Suitable permanent magnets are not believed to be particularly limited and may include elements such as, for example, Nd, Fe, B, Sm, Co, Al, Ni, the like, or any combination thereof.

Cooling of electric motor 10 may take place by transferring heat to the heat transfer fluid. The transferring step may be accomplished through direct or indirect cooling. In direct cooling, the heat transfer fluid may directly contact one or more portions of electric motor 10 that are in need of thermal management, including the permanent magnet. Indirect cooling may be realized when the heat transfer fluid is in thermal communication with one or more portions of electric motor 10 but without physically contacting at least stator 14, rotor 18, or the permanent magnets. The heat transfer fluid may be circulated through at least a portion of electric motor 10, or at least a portion of electric motor 10 may be immersed in the heat transfer fluid. Alternately, the heat transfer fluid may be sprayed onto the electric motor or any component thereof to promote cooling.

When electric motor 10 is operating, circulating the heat transfer fluid therethrough may promote heat removal to decrease the average operating temperature and the temperature of electrical windings 16.

The heat transfer fluids of the present disclosure may additionally contain one or more of commonly used additives including but not limited to dispersants, detergents, viscosity modifiers, antiwear additives, corrosion inhibitors, rust inhibitors, metal deactivators, extreme pressure additives, anti-seizure agents, wax modifiers, fluid-loss additives, seal compatibility agents, lubricity agents, anti-staining agents, chromophoric agents, defoamants, de-emulsifiers, densifiers, wetting agents, gelling agents, tackiness agents, colorants, and others. As noted above, conventional base oils (base stocks) may also be present in the heat transfer fluids. Suitable examples of the foregoing and amounts commonly used will be familiar to persons having ordinary skill in the art.

It is noted that many of the foregoing additives are shipped from an additive manufacturer as a concentrate, sometimes containing one or more additives together, within a base oil diluent. For example, the base oil diluent may comprise about 5 wt % to about 50 wt % of the concentrate before blending to form a heat transfer fluid. The additives useful in this disclosure do not necessarily have to be soluble in the heat transfer fluids and instead may be present as dispersed solids.

The one or more PAOs may afford beneficial thermal management effects when contacting an electric heat source, such as an electric motor or a portion thereof. For example, the one or more PAOs may afford improved operation of an electric motor, specifically improvements in power and current. The power improvement accords with Ohm's law (Equation 1)

$$P = V I = {V}^{2} / R = {I}^{2} R \qquad Equation 1$$

wherein P is power, V is voltage (potential), I is current, and R is resistance.

Resistance of a conductor is temperature dependent, typically with resistance increasing as a function of temperature. Per Ohm's law, decreasing the resistance leads to an increase in power at a constant current or voltage. Accordingly, by promoting thermal management with PAOs according to the present disclosure, higher currents may be used and the resistance may be kept the same or lowered while still achieving a comparable power output with smaller permanent magnet. Furthermore, pumping rate of the heat transfer fluid may be reduced. Methods for operating an electric motor may comprise, while the electric motor is operating, increasing the flow rate of the heat transfer fluid to result in increased power generated by the electric motor.

### Additional Embodiments

The present disclosure is further directed to the following non-limiting embodiments:
Embodiment 1. A method comprising:
   providing a heat transfer fluid comprising about 3 wt % to about 99.99 wt % of a polyalpha-olefin (PAO), based on total weight of the heat transfer fluid;
   wherein the PAO comprises about 10 mol % or less olefinic bonds and is a C22-C32 trimer of one of more C4-C12 linear alpha-olefins having a kinematic viscosity at 100° C. (Kv100), determined pursuant to ASTM D445, of about 1.8 cSt to about 4.5 cSt;
   contacting the heat transfer fluid with at least a portion of an electric heat source; and removing heat from the electric heat source with the heat transfer fluid.
Embodiment 2. The method of Embodiment 1, wherein the PAO has a kinematic viscosity at 100° C. (Kv100), determined pursuant to ASTM D445, of about 3.0 cSt to about 4.5 cSt, and a Noack volatility (NV), determined pursuant to ASTM D5800, of about 15% or less.
Embodiment 3. The method of Embodiment 2, wherein the PAO comprises C28-C32 polyalpha-olefin oligomers at a concentration of about 95 wt % or greater, based on total weight of the PAO.
Embodiment 4. The method of Embodiment 2 or Embodiment 3, wherein the PAO comprises C30 polyalpha-olefin oligomers at a concentration of about 95 wt % or greater, based on total weight of the PAO.
Embodiment 5. The method of any one of Embodiments 1-4, wherein the PAO has a thermal conductivity at 40° C. in a range of about 0.11 W·(m·° C.)⁻¹ to about 0.16 W·(m·° C.)⁻¹, determined pursuant to ASTM D7896-19.
Embodiment 6. The method of any one of Embodiments 1-5, wherein the PAO has a high-temperature high-shear viscosity of about 1.4 cP or less, determined pursuant to ASTM D4683 at 150° C.
Embodiment 7. The method of Embodiment 1, wherein the PAO has a kinematic viscosity at 100° C. (Kv100), determined pursuant to ASTM D445, of about 1.8 cSt to about 2.8 cSt, and a Noack volatility (NV), determined pursuant to ASTM D5800, of about 57% or less.
Embodiment 8. The method of Embodiment 7, wherein the PAO comprises C22-C26 polyalpha-olefin oligomers at a concentration of about 95 wt % or greater, based on total weight of the PAO.
Embodiment 9. The method of Embodiment 7 or Embodiment 8, wherein the PAO comprises C24 polyalpha-olefin oligomers at a concentration of about 95 wt % or greater, based on total weight of the PAO.
Embodiment 10. The method of any one of Embodiments 1-9, wherein the electric heat source comprises an electric motor.
Embodiment 11. The method of Embodiment 10, wherein the electric motor comprises a heat transfer fluid jacket, a rotor, and a heat transfer fluid inlet centrifugal extending through the rotor, and the heat transfer fluid is circulated through the heat transfer fluid jacket and the heat transfer fluid inlet centrifugal.
Embodiment 11A. The method of Embodiment 10, wherein the heat transfer fluid is sprayed onto the electric motor or any component thereof.
Embodiment 12. The method of Embodiment 10, Embodiment 11, or Embodiment 11A, wherein the electric motor further comprises at least one permanent magnet, and heat is transferred from the at least one permanent magnet to the heat transfer fluid.
Embodiment 13. The method of any one of Embodiments 10-12, further comprising:
   increasing a flow rate of the heat transfer fluid to the electric motor to promote increased power generation by the electric motor at a fixed current.
Embodiment 14. A system comprising:
   a heat transfer fluid comprising about 3 wt % to about 99.99 wt % of a polyalpha-olefin (PAO), based on total weight of the heat transfer fluid;
   wherein the PAO comprises about 10 mol % or less olefinic bonds and is a C22-C32 trimer of one of more C4-C12 linear alpha-olefins having a kinematic viscosity at 100° C. (Kv100), determined pursuant to ASTM D445, of about 1.8 cSt to about 4.5 cSt; and
   an electric heat source having at least a portion thereof in contact with the heat transfer fluid.
Embodiment 15. The system of Embodiment 14, wherein the electric heat source comprises an electric motor.
Embodiment 16. The system of Embodiment 15, wherein the electric motor comprises a heat transfer fluid jacket, a rotor, and a heat transfer fluid inlet centrifugal extending through the rotor, and the heat transfer fluid is circulated through the heat transfer fluid jacket and the heat transfer fluid inlet centrifugal.
Embodiment 17. The system of Embodiment 15 or Embodiment 16, wherein the heat transfer fluid flows through a circuit when contacting the electric motor.
Embodiment 18. The system of Embodiment 17, wherein the circuit comprises the heat transfer fluid jacket, the heat transfer fluid jacket is positioned around stator windings of the electric motor, and the heat transfer fluid jacket is connected to the heat transfer fluid inlet centrifugal.
Embodiment 19. The system of any one of Embodiments 15-18, wherein the electric motor comprises at least one permanent magnet.
Embodiment 20. The system of any one of Embodiments 14-19, wherein the PAO has a kinematic viscosity at 100° C. (Kv100), determined pursuant to ASTM D445, of about 3.0 cSt to about 4.5 cSt, and a Noack volatility (NV), determined pursuant to ASTM D5800, of about 15% or less.
Embodiment 21. The system of Embodiment 20, wherein the PAO comprises C28-C32 polyalpha-olefin oligomers at a concentration of about 95 wt % or greater, based on total weight of the PAO.
Embodiment 22. The system of Embodiment 20 or Embodiment 21, wherein the PAO comprises C30 polyalpha-olefin oligomers at a concentration of about 95 wt % or greater, based on total weight of the PAO.
Embodiment 23. The system of any one of Embodiments 20-22, wherein the PAO has a thermal conductivity at 40° C. of about 0.11 W·(m·° C.)⁻¹ to about 0.16 W·(m·° C.)⁻¹ as determined by ASTM D7896-19.
Embodiment 24. The system of any one of Embodiments 20-23, wherein the PAO has a high-temperature high-shear viscosity of about 1.4 cP or less, as determined pursuant to ASTM D4683 at 150° C.
Embodiment 25. The system of any one of Embodiments 14-19, wherein the PAO has a kinematic viscosity at 100° C. (Kv100), determined pursuant to ASTM D445, of about 1.8 cSt to about 2.8 cSt, and a Noack volatility (NV), determined pursuant to ASTM D5800, of about 57% or less.
Embodiment 26. The system of Embodiment 25, wherein the PAO comprises C22-C26 polyalpha-olefin oligomers at a concentration of about 95 wt % or greater, based on total weight of the PAO.
Embodiment 27. The system of Embodiment 26, wherein the PAO comprises C24 polyalpha-olefin oligomers at a concentration of about 95 wt % or greater, based on total weight of the PAO.
Embodiment 1′. A method comprising:
   providing a heat transfer fluid comprising about 3 wt % to about 99.99 wt % of a polyalpha-olefin (PAO), based on total weight of the heat transfer fluid;
   wherein the PAO comprises about 10 mol % or less olefinic bonds and has:
   i) a kinematic viscosity at 100° C. (Kv100), determined pursuant to ASTM D445, of about 3.0 cSt to about 4.5 cSt, and a Noack volatility (NV), determined pursuant to ASTM D5800, of about 15% or less; or ii) a kinematic viscosity at 100° C. (Kv100), determined pursuant to ASTM D445, of about 1.8 cSt to about 2.8 cSt, and a Noack volatility (NV), determined pursuant to ASTM D5800, of about 57% or less; and
   contacting the heat transfer fluid with at least a portion of an electric heat source; and removing heat from the electric heat source with the heat transfer fluid.
Embodiment 2′ The method of Embodiment 1′, wherein the PAO comprises C28-C32 polyalpha-olefin oligomers at a concentration of about 95 wt % or greater, based on total weight of the PAO.
Embodiment 3′. The method of Embodiment 2′, wherein the PAO comprises C30 polyalpha-olefin oligomers at a concentration of about 95 wt % or greater, based on total weight of the PAO.
Embodiment 4′. The method of any one of Embodiments 1′-3′, wherein the PAO is a trimer of one or more C4-C12 linear alpha-olefins.
Embodiment 5′. The method of any one of Embodiments 1′-4′, wherein the PAO has a thermal conductivity at 40° C. in a range of about 0.11 W·(m·° C.)⁻¹ to about 0.16 W·(m·° C.)⁻¹ as determined by ASTM D7896-19.
Embodiment 6′. The method of any one of Embodiments 1′-5′, wherein the PAO has a high-temperature high-shear viscosity of about 1.4 cP or less, as determined pursuant to ASTM D4683 at 150° C.
Embodiment 7′. The method of Embodiment 1′, wherein the PAO comprises C22-C26 polyalpha-olefin oligomers at a concentration of about 95 wt % or greater, based on total weight of the PAO.
Embodiment 8′. The method of Embodiment 7′, wherein the PAO comprises C24 polyalpha-olefin oligomers at a concentration of about 95 wt % or greater, based on total weight of the PAO.
Embodiment 9′. The method of any one of Embodiments 1′, 7′, or 8′, wherein the PAO is a trimer of one or more C4-C12 linear alpha-olefins.
Embodiment 10′. The method of any one of Embodiments 1′-9′, wherein the electric heat source comprises an electric motor.
Embodiment 11′. The method of Embodiment 10′, wherein the electric motor comprises a heat transfer fluid jacket, a rotor, and a heat transfer fluid inlet centrifugal extending through the rotor, and the heat transfer fluid is circulated through the a heat transfer fluid jacket and the heat transfer fluid inlet centrifugal.
Embodiment 11A′. The method of Embodiment 10′, wherein the heat transfer fluid is sprayed onto the electric motor or any component thereof.
Embodiment 12′. The method of Embodiment 10′, Embodiment 11′, or Embodiment 11A′, wherein the electric motor further comprises at least one permanent magnet, and heat is transferred from the at least one permanent magnet to the heat transfer fluid.
Embodiment 13′. The method of any one of Embodiments 10′-12′, further comprising: increasing a flow rate of the heat transfer fluid to the electric motor to promote increased power generation by the electric motor at a fixed current.
Embodiment 14′. A system comprising:
   a heat transfer fluid comprising about 3 wt % to about 99.99 wt % of a polyalpha-olefin (PAO), based on total weight of the heat transfer fluid;
   wherein the PAO comprises about 10 mol % or less olefinic bonds and has
   i) a kinematic viscosity at 100° C. (Kv100), determined pursuant to ASTM D445, of about 3.0 cSt to about 4.5 cSt, and a Noack volatility (NV), determined pursuant to ASTM D5800, of about 15% or less; or ii) a kinematic viscosity at 100° C. (Kv100), determined pursuant to ASTM D445, of about 1.8 cSt to about 2.8 cSt, and a Noack volatility (NV), determined pursuant to ASTM D5800, of about 57% or less; and an electric heat source having at least a portion thereof in contact with the heat transfer fluid.
Embodiment 15′. The system of Embodiment 14′, wherein the electric heat source comprises an electric motor.
Embodiment 16′. The system of Embodiment 15′, wherein the electric motor comprises a heat transfer fluid jacket, a rotor, and a heat transfer fluid inlet centrifugal extending through the rotor, and the heat transfer fluid is circulated through the heat transfer fluid jacket and the heat transfer fluid inlet centrifugal.
Embodiment 17′. The system of Embodiment 15′ or Embodiment 16′, wherein the heat transfer fluid flows through a circuit when contacting the electric motor.
Embodiment 18′. The system of Embodiment 17′, wherein the circuit comprises the heat transfer fluid jacket, the heat transfer fluid jacket is positioned around stator windings of the electric motor, and the heat transfer fluid jacket is connected to the heat transfer fluid inlet centrifugal.
Embodiment 19′. The system of any one of Embodiments 15′-18′, wherein the electric motor comprises at least one permanent magnet.
Embodiment 20′. The system of any one of Embodiments 14′-19′, wherein the PAO comprises C28-C32 polyalpha-olefin oligomers at a concentration of about 95 wt % or greater, based on the total weight of the PAO.
Embodiment 21′. The system of Embodiment 20′, wherein the PAO comprises C30 polyalpha-olefin oligomers at a concentration of about 95 wt % or greater, based on total weight of the PAO.
Embodiment 22′. The method of any one of Embodiments 14′-21′, wherein the PAO is a trimer of one or more C4-C12 linear alpha-olefins.
Embodiment 23′. The system any one of Embodiments 14′-22′, wherein the PAO has a thermal conductivity at 40° C. of about 0.11 W·(m·° C.)⁻¹ to about 0.16 W·(m·° C.)⁻¹, determined pursuant to ASTM D7896-19.
Embodiment 24′. The system of any one of Embodiments 14′-23′, wherein the PAO has a high-temperature high-shear viscosity of about 1.4 cP or less, determined pursuant to ASTM D4683 at 150° C.
Embodiment 25′. The system of any one of Embodiments 14′-19′, wherein the PAO comprises C22-C26 polyalpha-olefin oligomers at a concentration of about 95 wt % or greater, based on total weight of the PAO.
Embodiment 26′. The system of Embodiment 25′, wherein the PAO comprises C24 polyalpha-olefin oligomers at a concentration of about 95 wt % or greater, based on total weight of the PAO.
Embodiment 27′. The system of any one of Embodiments 14′-19′, 25′, or 26′, wherein the PAO is a trimer of one or more C4-C12 linear alpha-olefins.
Embodiment 28. The method of any of Embodiments 1-13, wherein the PAO has a heat capacity at 50° C. in a range of about 2.210 J/(g·° C.) to about 2.230 J/(g·° C.) as determined by ASTM D2766.

### Examples

To facilitate a better understanding of the embodiments of the present disclosure, the following examples of preferred or representative embodiments are given. In no way should the following examples be read to limit, or to define, the scope of the invention.

Example heat transfer fluids were evaluated to determine their thermal management properties in an electric motor. In this stage of testing, the PAOs were used as base oils with no additives or other components. Selected physical properties of the PAO components of the heat transfer fluids are specified in Table 1 below. Experimental Fluid 1 is SPECTRASYN MAX 3.5 (ExxonMobil Chemical Company). Experimental Fluid 2 is a PAO mixture containing predominantly C22-C26 PAOs. Comparative Fluid 1 is a commercial API Class II lubricant. Comparative Fluid 2 is a commercial API Class IV lubricant (SPECTRASYN 4, ExxonMobil Chemical Company). Comparative Fluid 3 is a commercial API Class III lubricant.

TABLE 1

| | | | | | Comparative | | Comparative | | Comparative | |
|---|---|---|---|---|---|---|---|---|---|---|
| Property and Test | Experimental | | Experimental | | Fluid 1 | | Fluid 2 | | Fluid 3 | |
| Method | Fluid 1 | | Fluid 2 | | (Class II) | | (Class IV) | | (Class III) | |
| KV100 (ASTM D445) | 3.5 | cSt | 2.36 | cSt | 2.57 | cSt | 4.1 | cSt | 4.21 | cSt |
| KV40 (ASTM D445) | 14.3 | cSt | 8.28 | cSt | 9.47 | cSt | 19 | cSt | 19.29 | cSt |
| Brookfield Viscosity | 1255 | cP | 560 | cP | — | | 2500 | cP | — | |
| (ASTM | | | | | | | | | | |
| SD2983C, −40° C.) | | | | | | | | | | |
| Viscosity Index | 129 | | 101 | | 100 | | 126 | | 124 | |
| (ASTM D2270) | | | | | | | | | | |
| Noack Volatility | <11.6 | wt % | 54.5 | wt % | 65.1 | wt % | <14.0 | wt % | 14.3 | wt % |
| (ASTM D5800, | | | | | | | | | | |
| 250° C.) | | | | | | | | | | |
| Pour Point (ASTM | <−78° | C. | −87.0° | C. | −24° | C. | −87° | C. | −27° C. | |
| D5950) | | | | | | | | | (ASTM D97) | |
| Flash Point (ASTM | 234° | C. | 203° | C. | — | | 220° | C. | 222° | C. |
| D92) | | | | | | | | | | |

The test motor was a permanent magnet synchronous motor, further characteristics of which are specified in Table 2 below.

TABLE 2

| Motor type | Permanent magnet synchronous motor | |
|---|---|---|
| | (PSM motor) | |
| Peak Power | 230 kW for 30 s | |
| Continuous Power | 100 | kW |
| Max Wheel Torque | 3,500 | N · m |
| Max E-Motor Torque | ~350 | N · m |
| E-Motor Max Speed | ~10,000 | rpm |

| | |
|---|---|
| Efficiency | >90% in test cycle |

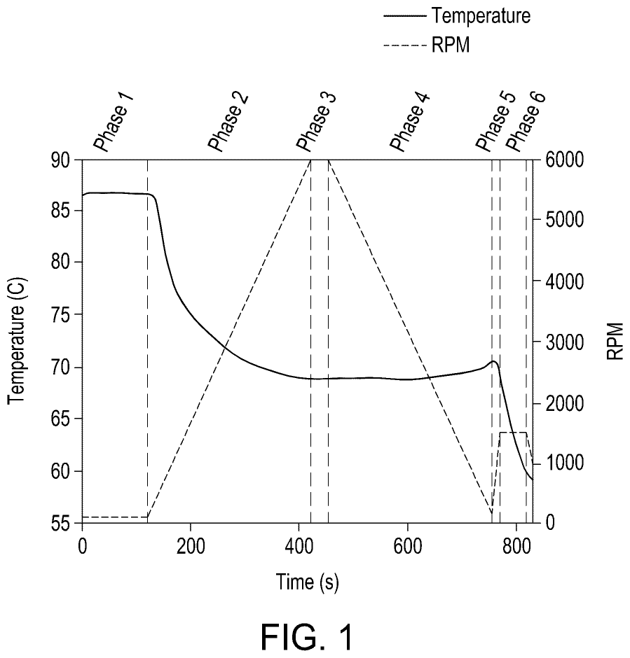

The above base oils were tested according to a multi-stage test procedure described further below. FIG. 1 is a graph showing the rpm and time and the corresponding temperature profile of the base oil. The temperature profile in FIG. 1 represents an average of all temperature sensors for a specific testing condition.

First, during a temperature stabilization phase, the base oils were circulated in the test motor at an operating speed of about 100 rpm. The coil current was switched on at this stage. Stabilization of the base oil temperature was achieved during this stage. Next, during a ramp up phase, the operating speed was increased from about 100 rpm to about 6,000 rpm over 30 s. During a subsequent hold phase, the electric motor was run at about 6,000 rpm for 30 s. A ramp-down phase was then conducted, during which the operating speed was decreased from about 6,000 rpm to about 100 over 30 s. Lastly, during a cool-down phase the coil current was switched off and the operating speed was increased to about 1500 rpm.

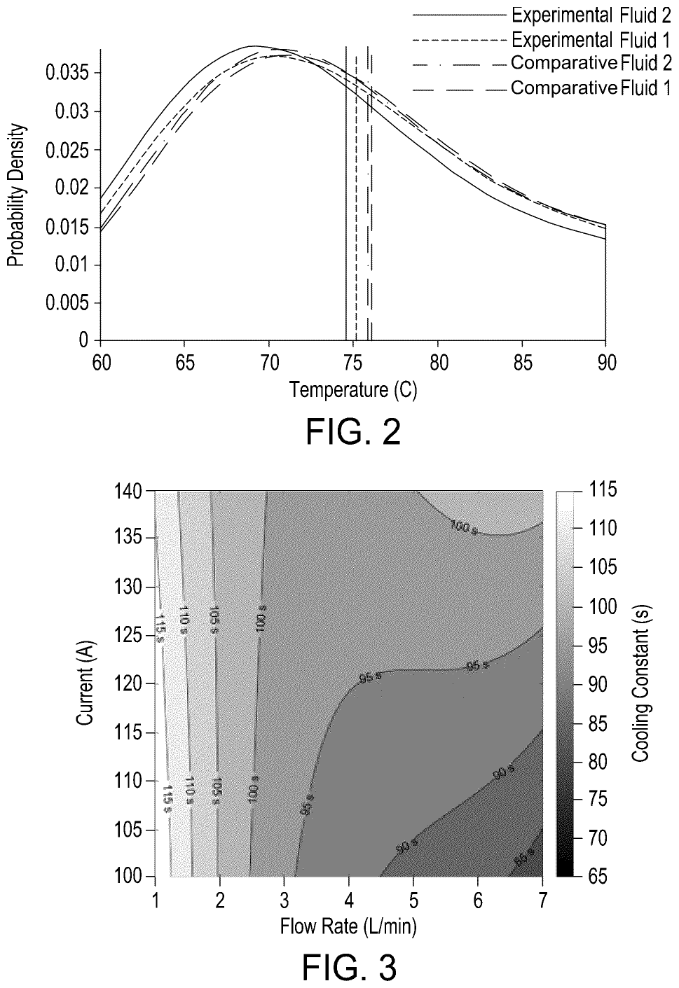

Parameters associated with the generic testing conditions included current (80, 100, 120, 140, and 150 A), the base oil circulation rate (1, 3, 5, and 7 L/min), and the centrifugal cooling temperature (30, 50, and 80° C.). FIG. 2 is a graph of probability density as a function of temperature for the various base oils under the tested operating conditions. As shown, Experimental Fluid 2 exhibited the best overall performance (lowest operating temperature). FIG. 2 represents an aggregation of all steady state temperatures (cooled) observed under all testing conditions for the tested fluids. A distribution was obtained for all of the steady state temperatures for each testing condition of for the tested fluids. Probability on the vertical axis indicates the probability that a certain temperature is observed during testing at one of the temperatures. The data shows that Experimental Fluid 2 has the lowest average temperature and has the highest chance of having a lower temperature at a sensor during testing.

By using Newton's law of cooling (Equation 2), the cooling time for each heat transfer fluid at given currents and flow rates was calculated and graphed.

$$T ( t ) = {T}_{coolant} + ( T ( 0 ) - {T}_{coolant} ) {e}^{- \frac{t}{τ}} \qquad Equation 2$$

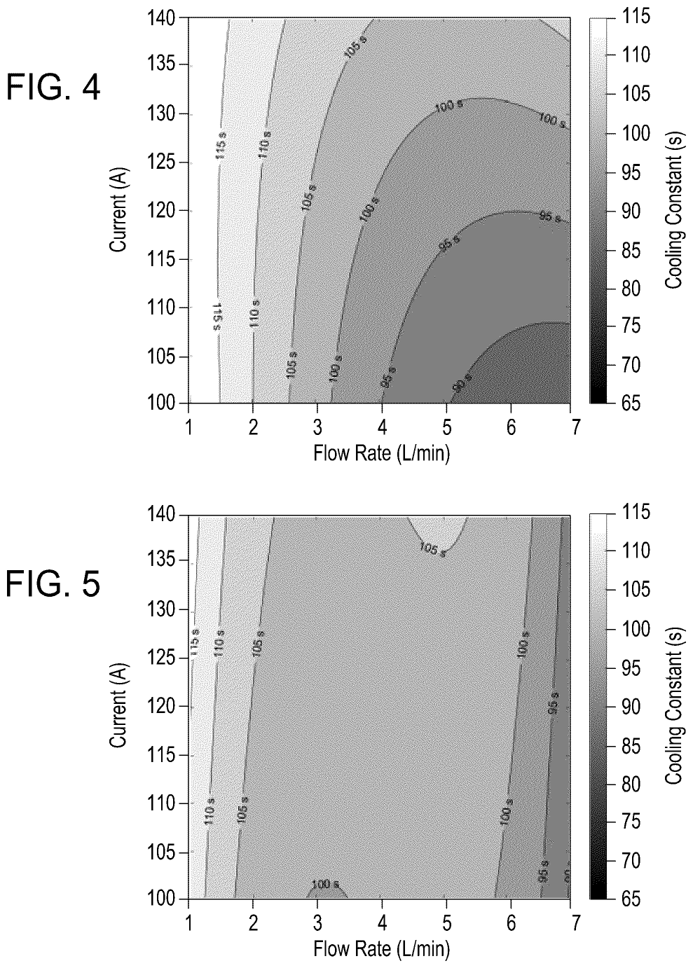

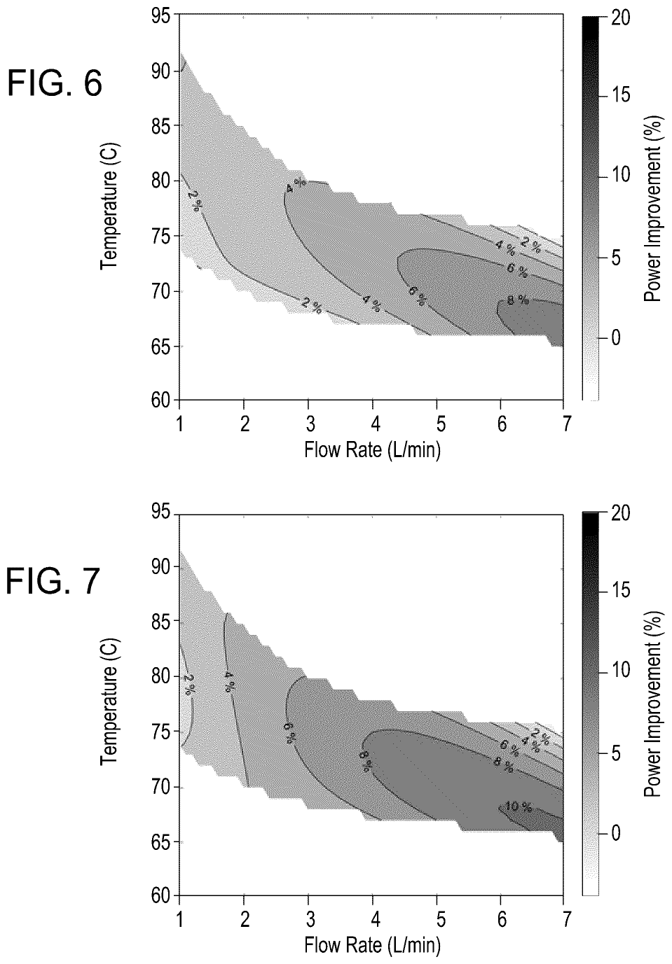

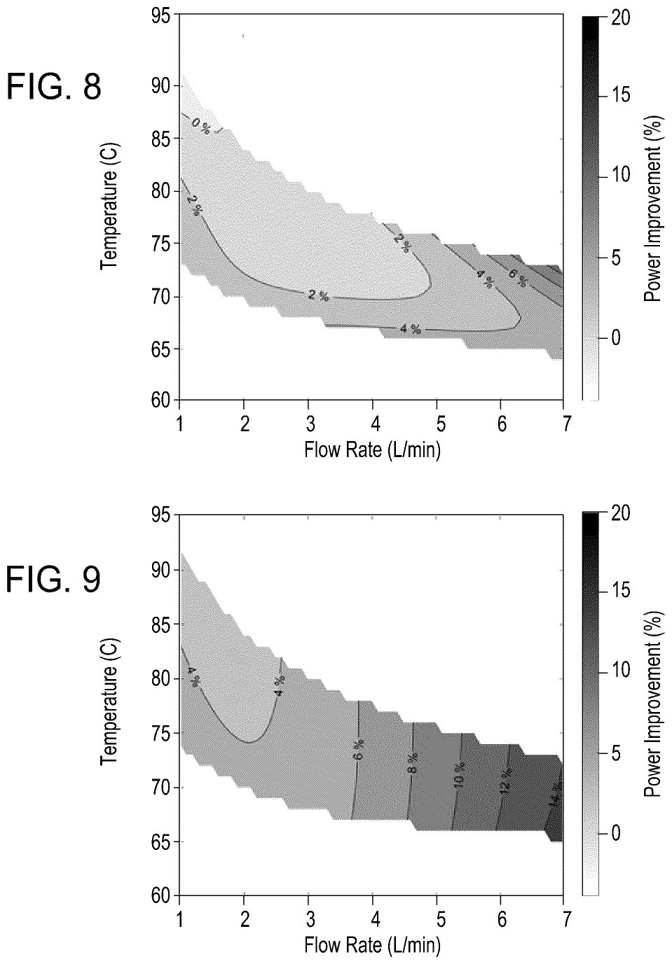

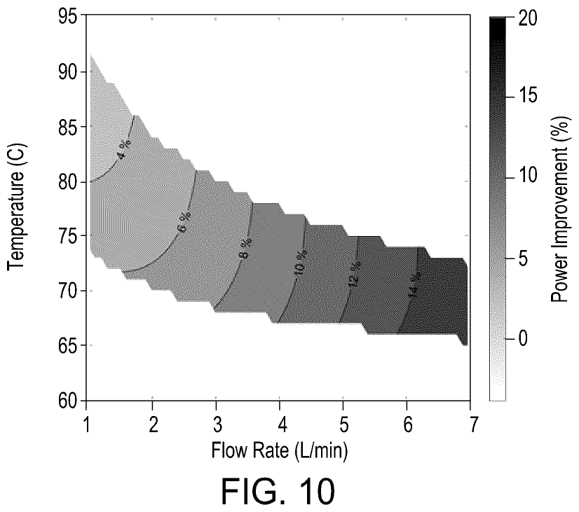

In Equation 2, T (t) is the temperature of the motor at time t, T_{coolant} is the temperature of the heat transfer fluid, τ is the cooling time, and T (0) is the initial temperature of motor. The cooling time is a measure of how fast a system has cooled and may be a figure of merit for comparing cooling properties of different heat transfer fluids. The cooling time may be used to compare different heat transfer fluids when a testing configuration is kept constant and only the heat transfer fluid is changed. FIGS. 3-5 are graphs showing the thermal cooling efficiency of the base oils in the test motor under the tested conditions. As shown, Experimental Fluid 1 (FIG. 3) had a lower cooling time than either Comparative Fluid 2 (FIG. 4) or Comparative Fluid 1 (FIG. 5). Darker areas in FIGS. 3-5 represent increased cooling performance. FIGS. 6-10 are graphs of temperature as a function of flow rate for various base oils in comparison to one another. FIGS. 6 and 7 show the relative performance of Experimental Fluid 1 in comparison to Comparative Fluid 2 and Comparative Fluid 1, respectively. FIGS. 8-10 show the relative performance of Experimental Fluid 2 in comparison to Experimental Fluid 1, Comparative Fluid 2, and Comparative Fluid 1, respectively. Darker areas of the gradient represent increased cooling performance and may demonstrate conditions that may tolerate higher current while maintaining a low operating temperature.

A simulation of the relative distribution of the base oils with respect to one another was also conducted. Simulated introduction of the base oils at 3 L/min and 50° C. to the centrifugal oil inlet of an electric motor operating at a speed of 1000 rpm was modeled, and the relative distribution of the base oils within the electric motor was determined. The performance of Experimental Fluid 2 and Experimental Fluid 1 were compared to that of Comparative Fluid 3. Comparative Fluid 3 exhibited the poorest distribution, and the average simulated temperature at the stator windings of the electric motor was determined to be 82.2° C. Experimental Fluid 2 and Experimental Fluid 1 exhibited better distribution within the electric motor than did the Comparative Fluid 3. Experimental Fluid 2 exhibited slightly better coverage than did Experimental Fluid 1. The average simulated temperatures at the stator windings were 78.0° C. and 77.7° C. for Experimental Fluids 1 and 2, respectively, both of which are lower than that afforded by Comparative Fluid 1.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentec. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A method comprising:
providing a heat transfer fluid comprising about 3 wt % to about 99.99 wt % of a polyalpha-olefin (PAO), based on total weight of the heat transfer fluid;
wherein the PAO comprises about 10 mol % or less olefinic bonds and is a C22-C32 trimer of one of more C4-C12 linear alpha-olefins having a kinematic viscosity at 100° C. (Kv100), determined pursuant to ASTM D445, of about 1.8 cSt to about 4.5 cSt;
contacting the heat transfer fluid with at least a portion of an electric heat source; and
removing heat from the electric heat source with the heat transfer fluid.

2. The method of claim 1, wherein the PAO:
(a) has a kinematic viscosity at 100° C. (Kv100), determined pursuant to ASTM D445, of about 3.0 cSt to about 4.5 cSt, and a Noack volatility (NV), determined pursuant to ASTM D5800, of about 15% or less;
(b) has a thermal conductivity at 40° C. in a range of about 0.11 W·(m·° C.)⁻¹ to about 0.16 W·(m·° C.)⁻¹, determined pursuant to ASTM D7896-19;
(c) has a high-temperature high-shear viscosity of about 1.4 cP or less, determined pursuant to ASTM D4683 at 150° C.;
(d) has a kinematic viscosity at 100° C. (Kv100), determined pursuant to ASTM D445, of about 1.8 cSt to about 2.8 cSt, and a Noack volatility (NV), determined pursuant to ASTM D5800, of about 57% or less; or,
(e) any combination of (a) through (d).

3. The method of claim 2, wherein the PAO comprises C28-C32 polyalpha-olefin oligomers at a concentration of about 95 wt % or greater, based on total weight of the PAO.

4. The method of claim 3, wherein the PAO comprises C30 polyalpha-olefin oligomers at a concentration of about 95 wt % or greater, based on total weight of the PAO.

5. The method of claim 2, wherein the PAO comprises C22-C26 polyalpha-olefin oligomers at a concentration of about 95 wt % or greater, based on total weight of the PAO.

6. The method of claim 8, wherein the PAO comprises C24 polyalpha-olefin oligomers at a concentration of about 95 wt % or greater, based on total weight of the PAO.

7. The method claim 1, wherein the electric heat source comprises an electric motor and wherein the electric motor comprises a heat transfer fluid jacket, a rotor, and a heat transfer fluid inlet centrifugal extending through the rotor, and the heat transfer fluid is circulated through the heat transfer fluid jacket and the heat transfer fluid inlet centrifugal.

8. The method of claim 7, wherein the heat transfer fluid is sprayed onto the electric motor or a component thereof.

9. The method of claim 7, wherein the electric motor further comprises at least one permanent magnet, and heat is transferred from the at least one permanent magnet to the heat transfer fluid.

10. The method of claim 7, further comprising:
increasing a flow rate of the heat transfer fluid to the electric motor to promote increased power generation by the electric motor at a fixed current.

11. A system comprising:
a heat transfer fluid comprising about 3 wt % to about 99.99 wt % of a polyalpha-olefin (PAO), based on total weight of the heat transfer fluid;
wherein the PAO comprises about 10 mol % or less olefinic bonds and is a C22-C32 trimer of one of more C4-C12 linear alpha-olefins having a kinematic viscosity at 100° C. (Kv100), determined pursuant to ASTM D445, of about 1.8 cSt to about 4.5 cSt; and
an electric heat source having at least a portion thereof in contact with the heat transfer fluid.

12. The system of claim 11, wherein the electric heat source comprises an electric motor and wherein the electric motor comprises a heat transfer fluid jacket, a rotor, and a heat transfer fluid inlet centrifugal extending through the rotor, and the heat transfer fluid is circulated through the heat transfer fluid jacket and the heat transfer fluid inlet centrifugal.

13. The system of claim 12, wherein the heat transfer fluid flows through a circuit when contacting the electric motor.

14. The system of claim 13, wherein the circuit comprises the heat transfer fluid jacket, the heat transfer fluid jacket is positioned around stator windings of the electric motor, and the heat transfer fluid jacket is connected to the heat transfer fluid inlet centrifugal.

15. The system of claim 11, wherein the electric motor comprises at least one permanent magnet.

16. The system of claim 11, wherein the PAO has:
(a) has a kinematic viscosity at 100° C. (Kv100), determined pursuant to ASTM D445, of about 3.0 cSt to about 4.5 cSt, and a Noack volatility (NV), determined pursuant to ASTM D5800, of about 15% or less;
(b) has a thermal conductivity at 40° C. in a range of about 0.11 W·(m·° C.)⁻¹ to about 0.16 W·(m·° C.)⁻¹, determined pursuant to ASTM D7896-19;
(c) has a high-temperature high-shear viscosity of about 1.4 cP or less, determined pursuant to ASTM D4683 at 150° C.;
(d) has a kinematic viscosity at 100° C. (Kv100), determined pursuant to ASTM D445, of about 1.8 cSt to about 2.8 cSt, and a Noack volatility (NV), determined pursuant to ASTM D5800, of about 57% or less; or,
(e) any combination of (a) through (d).

17. The system of claim 16, wherein the PAO comprises C28-C32 polyalpha-olefin oligomers at a concentration of about 95 wt % or greater, based on total weight of the PAO.

18. The system of claim 17, wherein the PAO comprises C30 polyalpha-olefin oligomers at a concentration of about 95 wt % or greater, based on total weight of the PAO.

19. The system of claim 16, wherein the PAO comprises C22-C26 polyalpha-olefin oligomers at a concentration of about 95 wt % or greater, based on total weight of the PAO.

20. The system of claim 19, wherein the PAO comprises C24 polyalpha-olefin oligomers at a concentration of about 95 wt % or greater, based on total weight of the PAO.
